(19) United States
(12) Patent Application Publication
(10) Pub. No.: US 2004/0253454 A1
(43) Pub. Date: Dec. 16, 2004

(54) Protective coating for a glass-ceramic surface

(75) Inventors: Theodore A. Wegert, Louisville, KY (US); Karen Cary, Louisville, KY (US); Michael Schulz, Chattanooga, TN (US); Daniel Leeroy Whiteside, Dalton, GA (US)

Correspondence Address: VOLPE AND KOENIG, P.C., UNITED PLAZA, SUITE 1600, 30 SOUTH 17TH STREET, PHILADELPHIA, PA, 19103, US

(73) Assignee: Schott Corporation, Yonkers, NY

(21) Appl. No.: 10/757,671

(22) Filed: Jan. 14, 2004

Related U.S. Application Data
(60) Provisional application No. 60/450,247, filed on Feb. 26, 2003.

(51) Int. Cl. B05D 3/02; B32B 9/00

(52) U.S. Cl. 428/428; 427/421.1; 428/447

(57) ABSTRACT

A method for protecting a glass-ceramic surface by applying a layer of silicone to the surface is provided. The method involves utilizing an automated spray nozzle or roller device connected to a robotic arm which applies silicone to the glass-ceramic surface in areas prone to scratching. A cooktop including a glass-ceramic cooking surface with a protective layer of silicone applied thereto is also provided. The layer of silicone is provided on only on an underside portion of the cooktop, opposite a top portion designed to receive cooking implements. Further provided is a method for manufacturing the above described cooktop.

### CROSS REFERENCE TO RELATED APPLICATION

This application claims the benefit of U.S. Provisional Patent Application Ser. No. 60/450,247, filed Feb. 26, 2003, which is incorporated by reference as if fully set forth.

### BACKGROUND

The present invention is directed to a protective coating for a glass-ceramic surface, such as a smooth cooktop, and more particularly, to an RTV silicone coating to protect a contact area of the glass-ceramic surface from any articles which contact it.

A growing percentage of cooktops in the U.S. and in the European markets are glass-ceramic smoothtops. These units are rapidly replacing traditional resistance coil units due to both aesthetic and functional advantages. The heating surfaces of glass-ceramic smoothtop cooktops are generally designed for strength and temperature resistance. However, the underside of glass-ceramic cooktops are susceptible to scratching. While this was not previously believed to have an impact on these cooktops, it has been discovered that even small scratches can weaken a glass-ceramic cooktop making it susceptible to breakage during normal usage at a later point in time.

Additionally, after the glass-ceramic cooktops are shipped from the factory, the underside surfaces of the cooktops can be scratched during installation by contact with hard surfaces such as metal brackets and/or countertops in which they are installed. This is particularly true in the case of frameless or countertop installation in a home where a contractor or homeowner is generally not as careful as would be desired in handling these units. In such cases, the cooktops are provided without a porcelain, metal or plastic frame to protect the glass-ceramic around its edges. Instead, the edge of the glass-ceramic cooking surface rests directly on the kitchen countertop. The glass-ceramic cooking surface can be unknowingly scratched by the installer.

A scratch may significantly weaken the surface causing the glass-ceramic cooking surface to later crack under what would be considered routine pressure, for example from a dropped pot or pan, or due to thermal cycling. Such failures are potentially dangerous to the consumer and are costly to repair.

### SUMMARY

The present invention provides a method for protecting a glass-ceramic surface by applying a generally uniform layer of silicone to the surface. The method preferably involves utilizing an automated spray nozzle or roller device connected to a robotic arm which applies silicone to the glass-ceramic surface in areas prone to scratching, abrasion, or other damage. The silicone can also be applied manually using a spray gun or other suitable applicators.

The invention further provides a cooktop including a glass-ceramic cooking surface and a protective layer of silicone applied at least on an underside thereof. In one embodiment the layer of silicone is provided only on an underside portion of the glass-ceramic surface, opposite a top portion designed to receive cooking implements. In another embodiment, the layer of silicone is applied in a gas burner receiving area to prevent the glass-ceramic surface from being damaged by a gas burner and to allow for a seal between the gas burner and the gas burner receiving area. Methods for manufacturing the above described cooktops are also provided.

The invention further provides a cooktop including cooktop grates with a layer of silicone applied thereto. The cooktop grates contact a glass-ceramic surface of the cooktop, and the layer of silicone protects the glass-ceramic surface from being damaged by the cooktop grates.

### BRIEF DESCRIPTION OF THE DRAWINGS

FIG. 1 is a view of a spray nozzle application device shown applying an RTV silicone coating according to a preferred embodiment of the present invention.

FIG. 2 is a partial sectional view of a gas burner glass-ceramic cooktop according to a preferred embodiment of the present invention.

FIG. 3 is a partial sectional view of a gas burner glass-ceramic cooktop according to a preferred embodiment of the present invention.

FIG. 4 is a view of a roller application device shown applying an RTV silicone coating according to a preferred embodiment of the present invention.

### DETAILED DESCRIPTION OF THE PREFERRED EMBODIMENT

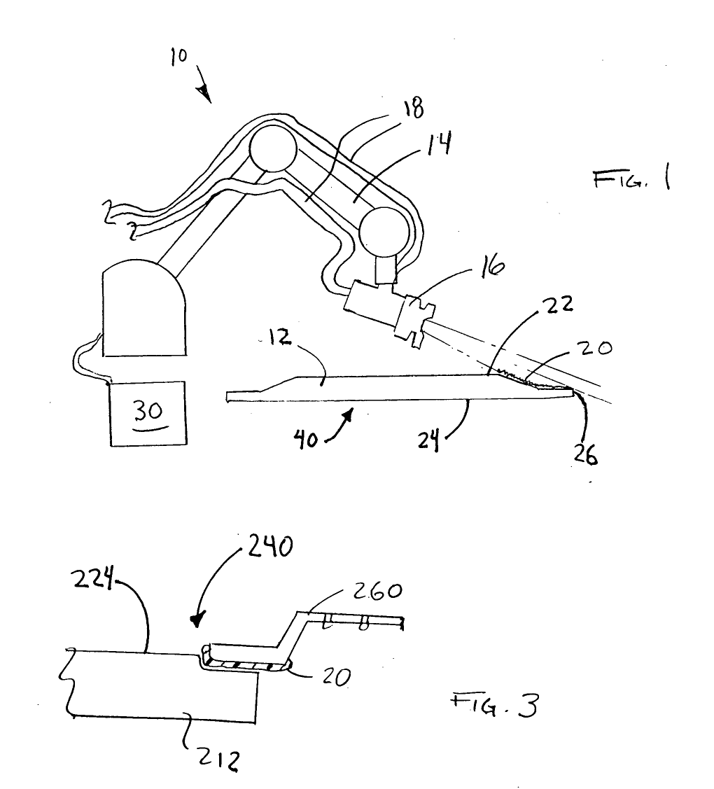

Referring to FIG. 1, shown is an application device 10 for coating at least a portion of a glass-ceramic surface 12 of a smooth cooktop 40 with an RTV silicone 20 in accordance with a preferred embodiment of the present invention. The silicone 20 protects the surface 12 from scratching and abrasions.

The device 10 preferably includes a robotic arm 14 controlled automatically by a programmable controller 30. Alternatively, the robotic arm 14 may be controlled manually or semi-automatically. A spray nozzle 16 is supported by the robotic arm 14 and is connected via hoses 18 to a source of liquid RTV silicone, which is preferably under pressure, or alternatively gravity fed. A supply of pressurized air may also be provided, via one of hoses 18, to adequately atomize the silicone 20 dispensed from the nozzle 16. The nozzle 16 is preferably of a known type for use in connection with spraying atomized high viscosity fluids. Alternatively, the RTV silicone 20 may be applied manually to the glass-ceramic surface 12 using a conventional or HVLP hand-held spray gun, of the type known in the art, employing a hand-trigger or foot peddle controls.

The RTV silicone 20 is preferably a condensation curing silicone of the type commonly used in cooktop assemblies as a structural adhesive and as a sealant. Alternatively, the silicone 20 may be heat curable, addition curable, UV curable or a type which cures in any suitable manner. Silicone is able to withstand exposure to the high temperatures encountered in cooktop applications. Sustained long-term temperatures up to 250° C. and shorter-term spikes of temperatures between 250° C. and 300° C. will not degrade commercially available silicones for such application.

The RTV silicone 20 adheres very effectively to the glass-ceramic surface 12 and has a viscosity that allows it to be sprayed with an adequate thickness to prevent scratching and provide cushioning. Alternatively, the silicone 20 may additionally provide a moisture tight seal to prevent water or condensation from contacting electrical components located on an underside portion 22 of the glass-ceramic surface 12.

The programmable controller 30 is used to direct the robotic arm 14 to carry the spray nozzle 16 at a desired speed along a desired path with respect to the cooktop 40 to apply an even layer of silicone 20. The angle of the spray nozzle 16 relative to the cooktop 40 is preferably varied such that the cooktop 40 itself acts as a mask for areas which are not to be coated with the RTV silicone 20, such as vertical edges 26 of the glass-ceramic surface 12. Alternatively, a shield, cutout mask or making tape, applied manually or automatically, may be employed in order to shield any areas of the glass-ceramic surface which are not to be coated by the coating process.

Alternatively, the spray nozzle 16 may be replaced by a roller, brush or pad which applies the silicone 20 by direct contact with the glass-ceramic surface 12. Referring to FIG. 4, an application device 310, similar to the application device 10, is shown. The application device 310 includes a roller applicator 316 supported by a robotic arm 314 and supplied with silicone 20 via hoses 318. A controller 330, similar to the controller 30, controls the motion of the arm 314 and the supply of silicone 20 to the roller applicator 316. Also, other methods known to those skilled in the art, such as silk screening, may be used to apply silicone to the surface 12.

In a preferred embodiment, the RTV silicone 20 is preferably applied in coatings of at least 0.003 inches thick on the glass-ceramic surface 12 on its underside portion 22. More preferably, the coating is approximately 0.008 to 0.020 inches thick. Thicknesses in this range have been found to be sufficient to prevent scratching during handling, facilitating manufacturing of the cooktop 40 by preventing the occurrence of small scratches often missed during the inspection process. The RTV silicone 20 further provides the benefit of preventing scratches and abrasions during installation of the cooktop 40, preventing damage which might cause immediate or future failures. Preferably, silicone 20 is not applied to a top portion 24 of the glass-ceramic surface 12 where cooking implements are used and aggressive cleaning or scrubbing may be required. Further, depending on the application, it may be required that only select areas of the underside portion 22 which are susceptible to damage be coated with silicone.

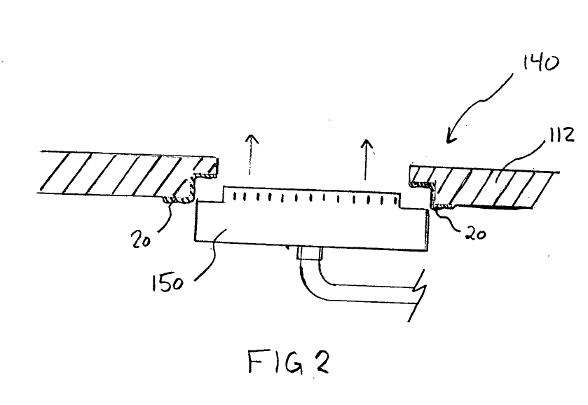

Referring now to FIG. 2, a partial sectional view of a gas burner glass-ceramic cooktop 140 according to another preferred embodiment of the present invention is shown. In this embodiment, the RTV silicone 20 is preferably sprayed, or otherwise applied in a thin coating on a glass-ceramic surface 112 of the cooktop 140 in an area for receiving a gas burner 150 which is formed for attachment on an underside portion of the gas burner glass-ceramic cooktop 140. The RTV silicone 20 provides a protective coating for the glass-ceramic surface 112 to protect it from scratches and abrasions. Preferably the gas burner 150 is installed prior to full curing of the silicone 20. In this manner, after the silicone 20 is cured, it acts as a high temperature seal in the area where the gas burner unit is attached preventing ingress of food, liquid and debris. Alternatively, the silicone 20 may be applied directly to the gas burner 150 in areas that are to contact the glass-ceramic surface.

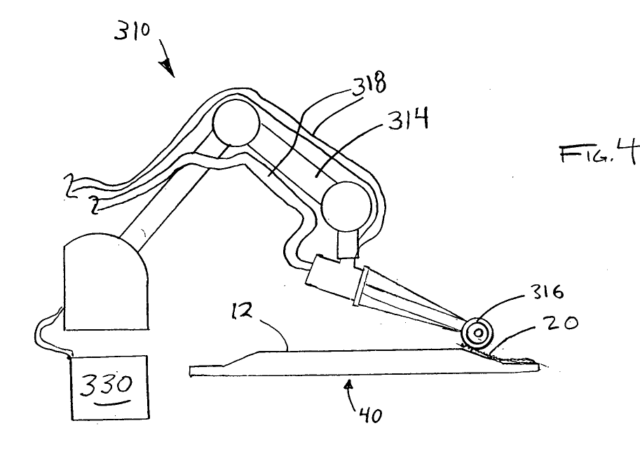

FIG. 3 shows a partial sectional view of a gas burner glass-ceramic cooktop 240 according to another preferred embodiment of the present invention. The cooktop 240 includes cooktop grates 260 which contact a top portion 224 of a glass-ceramic surface 212. The cooktop grates 260 are preferably formed to support cooking implements and are provided with a coating of RTV silicone 20 on a bottom edge thereof in an area which contacts the glass-ceramic surface 212 of the cooktop 240. This provides scratch and abrasion protection for the glass-ceramic surface 212. As described above, the silicone 20 is temperature resistant, and is not easily scrubbed from the grate surface. The glass-ceramic surface 212 remains uncoated on portions accessible to a consumer so that it can be easily cleaned after use in the normal manner, while still being protected from scratching by the coating 20 on the underside of the gas grate.

While the preferred embodiments of the invention have been described in detail, the invention is not limited to the specific embodiments described above which should be considered as merely exemplary. Further modifications and extensions of the present invention may be developed and all such modifications are deemed to be within the scope of the present invention as defined by the appended claims.

What is claimed is:

1. A method of protecting a glass-ceramic surface comprising applying a layer of silicone to at least a portion of the glass-ceramic surface.

2. The method according to claim 1, wherein the step of applying includes spraying the silicone through a spray nozzle.

3. The method according to claim 2, further comprising masking a first portion of the glass-ceramic surface with a second portion of the glass-ceramic surface, whereby the second portion receives a layer of the RTV silicone applied thereto and the first portion remains substantially free of RTV silicone.

4. The method according to claim 1, wherein the step of applying includes spraying the silicone through a spray nozzle positioned on a robotic arm.

5. The method according to claim 4, further comprising controlling the robotic arm automatically with a controller.

6. The method according to claim 1, wherein the step of applying includes rolling the silicone on the glass-ceramic surface using a roller.

7. The method according to claim 1, wherein the step of applying includes applying the layer of silicone to a portion of the glass-ceramic surface which is adapted to contact an associated element.

8. The method according to claim 1, wherein the step of applying the layer of silicone includes applying a layer of RTV silicone.

9. A method of manufacturing a cooktop comprising:
providing a glass-ceramic surface having a first side for receiving cooking implements and a second side, opposite the first side; and
applying a layer of silicone to at least a portion of the second side.

10. The method according to claim 9, wherein the step of applying includes applying the layer of silicone so that the first side remains substantially free of silicone.

11. The method according to claim 9, wherein the step of applying includes applying the layer of silicone in a burner receiving area and further comprising connecting a burner in the burner receiving area, wherein the burner contacts the layer of silicone in the burner receiving area.

12. The method according to claim 11, wherein the step of connecting the burner includes attaching the burner to form a seal between the burner receiving area and the burner, whereby solids and liquids are prevented from passing through the cooktop in the burner receiving area.

13. The method according to claim 9, wherein the step of applying includes spraying the silicone through a spray nozzle.

14. The method according to claim 9, wherein the step of applying includes applying the layer with a thickness of greater than 0.003 inches.

15. The method according to claim 9, wherein the step of applying includes applying the layer with a thickness between approximately 0.008 and 0.020 inches.

16. A cooktop comprising a glass-ceramic cooking surface and a layer of protective silicone applied to at least a portion of the glass-ceramic cooking surface.

17. The cooktop according to claim 16, wherein the glass-ceramic surface includes a first side for receiving cooking implements and a second side, opposite the first side, and wherein the layer of protective silicone is applied to at least a portion of the second side.

18. The cooktop according to claim 17, wherein the silicone is an RTV silicone.

19. The cooktop according to claim 17, wherein the layer of protective silicone is between approximately 0.008 and 0.020 inches thick.

20. A cooktop comprising:
a glass-ceramic cooking surface;
at least one of a gas burner and a cooktop grate which contact the glass-ceramic surface; and
a layer of protective silicone applied to at least one of the glass-ceramic cooking surface and one of the at least one of the gas burner and the cooktop grate.

21. The cooktop according to claim 20, wherein the glass-ceramic surface includes a burner receiving area, wherein the layer of silicone is applied to at least one of the burner receiving area and a portion of the burner, and the burner is connected to the glass-ceramic surface in the burner receiving area with the layer of protective silicone disposed therebetween.

22. The cooktop according to claim 21, wherein the layer of silicone forms a seal between the burner and the glass-ceramic surface, whereby solids and liquids are prevented from passing through the cooktop in the burner receiving area.

23. The cooktop according to claim 20, wherein the glass-ceramic surface includes a grate receiving area, and the cooktop grate includes a mounting surface in contact with the grate receiving area, wherein the layer of protective silicone is applied to the mounting surface for protection of the glass-ceramic cooking surface.
